(19) United States
(12) Patent Application Publication
(10) Pub. No.: US 2025/0390722 A1
(43) Pub. Date: Dec. 25, 2025

(54) Interactive AI Agent for Enhanced User Engagement and Experience

(71) Applicant: LiveX AI Incorporated, Palo Alto, CA (US)

(72) Inventors: Jia Li, Palo Alto, CA (US); Yao Zhao, Fremont, CA (US); Yujia Li, Palo Alto, CA (US)

(21) Appl. No.: 19/243,167

(22) Filed: Jun. 19, 2025

Related U.S. Application Data
(60) Provisional application No. 63/662,394, filed on Jun. 20, 2024.

(51) Int. Cl. G06N 3/0475; G06N 3/0442

(52) U.S. Cl. CPC G06N 3/0475; G06N 3/0442

(57) ABSTRACT

Systems and methods of an interactive AI agent to interact with one or more users at the same time of a product or service are disclosed. A primary modality module is used to understand the input of one or more information channels from one or more users and to generate streaming content output. The primary modality comprises a gated fusion network to ground multi-channel information to fused information and an AI model to understand the fused information and generate output. A user interface is used to interface with one or more users. Overall, such systems and methods provide interactive communication, enhanced user engagement and experience with one or more users simultaneously.

### TECHNICAL FIELD

The embodiments provided herein a system and a method of interactive agent to engage one or more users at the same time of a product or service, and more particularly, a method utilizing artificial intelligence (AI) program to provide interactive communication, enhanced user engagement and experience in various industries and applications with one or more users simultaneously in relation to a product or service. This application claims the benefit of and priority to U.S. provisional application No. 63/662,394, filed Jun. 20, 2024, the contents of which are incorporated by reference herein in their entirety.

### BACKGROUND

User interaction and engagement is a critical link of improving user experience of a product or service. Such user interaction and engagement can happen via website, application programs of mobile phones or other terminal devices, or hologram or holobox, etc. There are a couple of traditional ways to interact with users to improve their engagement with a business with the goal of providing better user experience in an engaging, efficient, and versatile way.

Last generation of chatbot with pre-defined text responses can provide information to users based on static information. Such static information is stored in a digital storage space like memory, cloud, database, etc. and may be updated once a while. Based on such stored static information, chatbot can provide information to users or answer questions once inquired by users but only reciting those stored static information. Such customer engagement is less interactive because it is neither real-time updated nor customized to the specific customer engagement situation.

Similarly, interactive Frequent Asked Questions is another way to interact with users. In this scenario, normally there is an interactive frequently asked questions section where users can select the question of interest by clicking on the question. The system reveals answers to the selected questions, and the system may further provide a couple of related questions the user might be further interested in knowing. Most of the time necessary information could be provided to address users' questions, but in a less automatic and dynamic way.

Another alternative in the era without the involvement of AI technologies is live customer support. This way, of course, can provide live customer support to address users' questions and need in a real-time and dynamic manner. But because it involves live customer support representatives, it is dependent on human labor and causes cost control issue and scalability issues to businesses.

Thereafter, some websites adopted AI powered chatbots as an interactive customer service. Often times, these AI chatbots are text-based. Consumers turn to online chatbots and exchange text messages for guidance on how to use the product or service. However, several drawbacks are associated with text-based chatbots. The ability of chatbot to accurately interpret and understand users' queries in natural language is limited. For example, a chatbot lacks appropriate understanding of context over a conversation and hence it can't handle multi-turn interactions effectively with users. A chatbot also struggles to understand and appropriately respond to complex human emotional cues based on text. A similar approach involves voice assistants, which provides slightly more interactive user experience.

A dynamic, interactive, and personalized interaction experience is broadly applicable in many industries and applications. For example, it can be used in e-commerce applications to improve customer engagement, customer service, and customer satisfaction. It can also be used in Software-as-a-Service applications to improve the interaction of a software system with its users, mostly developers, engineers, or end users. It can further be used in healthcare patient engagement applications to improve communication efficiency between patients, healthcare professionals, and the healthcare provision system. Moreover, it can be used in sports and entertainment industries, like sports fan engagement, animation IP figures engagement, etc.

To maintain or achieve a higher level of a user's satisfaction for the applications above, there is a need for a system providing a more dynamic, interactive, and personalized interaction for user support with multiple users simultaneously, and ultimately to improve the user experience of the product or service.

### SUMMARY

Generally provided are a system and method of an interactive agent to interact with one or more users at the same time of a product or service. Such system and method involve enhancing user engagement through an immersive experience enabled by AI agents or AI avatars. By integrating a dynamic and responsive AI-driven video or avatar interface, the invention aims to provide a more personalized and engaging user experience. This approach not only captures the attention of users but also facilitates seamless interaction, engagement, and transaction processes.

In accordance with one embodiment, a system of interactive AI agent with one or more modalities and a user interface is provided. Out of the multiple modalities, the primary modality comprises a gated fusion network to ground one or more video information, image information, text information, and voice information to fused information suitable for the process of an AI model, and an AI model to understand the fused information and generate output content to be streamed to one or more users via the user interface. The user interface detects extrinsic and intrinsic stimulations as input and streams the output content generated by the AI model.

In accordance with another embodiment, the system is configured to engage with multiple users simultaneously, with personalized input understanding and personalized output generating capabilities, supporting multilingual communication, handling a wide range of tasks. Simultaneous interaction with multiple users makes the system scalable and suitable for businesses of all sizes in a variety of industries and applications. High level of personalization and the adoption of avatar technologies provide a more lifelike and engaging interaction, capturing user attention effectively, and leading to a high level of user satisfaction and loyalty. Multilingual capability broadens the scope of targeting user audience. And because of the capability of the AI agent system to handle a wide range of tasks including taking certain actions, the system offers a comprehensive solution than informative role only.

In accordance with another embodiment, the system of interactive AI agent comprises one primary modality, and one or more secondary modalities. The primary modality and the one or more secondary modalities are AI models based on one or more forms of media, e.g., language model, video model, audio model, etc. These models are configured to adapt to various access points such as various forms of information (video, audio, image, text, etc.) and improve the versatility integration of the system. The flexibility of deployment of the system makes it easy for businesses to integrate the technology into existing infrastructure.

In accordance with yet another embodiment, a method for interacting with users of a product or service is provided. The method includes the steps of reading one or more of video information, image information, text information, and voice information by one or more modalities, grounding received information to fused information by a gated fusion network, understanding said fused information by an AI model, generating output content in one or more forms of video, image, text, voice, and action by the AI model, and delivering the output content to one or more users by a user interface.

The interactive AI agent system is primarily applicable to the following industries and applications. It is configured to enhance customer engagement and boost sales through interactive AI-driven avatars and videos in e-commerce applications. It is configured to provide interactive experience for engaging website, applications, or other interface terminals' visitors and promote products and services in digital marketing applications. It is configured to offer real-time AI-driven assistance to answer customers' queries, guide customers, and provide support in customer service applications. It is configured to create immersive shopping experience with AI-generated avatars and videos in retailing applications. It is configured to broadcast live events or promotions in an engaging format with interactive elements in event management. It is configured to deliver interactive learning experience with AI avatars and multilingual support in training and education applications. It is configured to offer engaging interactions and content delivery through AI technologies in entertainment applications. It is configured to provide virtual assistance and support through AI avatars for patent engagement and information dissemination in healthcare and telemedicine applications. It is configured to enhance customer experience with AI-driven interaction for service information and booking assistance in hospitality applications. It is configured to create AI-driven engaging content and interactions for social media platforms in social media applications.

This summary is provided to efficiently present the general concept of the invention and should not be interpreted as limiting the scope of the claims.

### BRIEF DESCRIPTION OF THE DRAWINGS

For the purpose of facilitating understanding of the embodiments, the accompanying drawings and description illustrate embodiments thereof, their various structures, construction, method of operation, and many advantages that may be understood and appreciated. According to common practice, the various features of the drawings are not drawn to scale. On the contrary, the dimensions of the various features are arbitrarily expanded or reduced for clarity.

FIG. 1 is a diagram of the architecture of the interactive AI agent system in accordance with aspects of the invention for interactive communication, enhanced user engagement and experience; and

FIG. 2 is a workflow of using the interactive AI agent system to handle user input and generate output in accordance with aspects of the invention for interactive communication, enhanced user engagement and experience.

### DETAILED DESCRIPTION

Many alternative embodiments of the present aspects may be appropriate and are contemplated, including as described in these detailed embodiments, though also including alternatives that may not be expressly shown or described herein but as obvious variants or obviously contemplated according to one of ordinary skill based on reviewing the totality of this disclosure in combination with other available information. For example, it is contemplated that features shown and described with respect to one or more embodiments may also be included in combination with another embodiment even though not expressly shown and described in that specific combination.

For purpose of efficiency, reference numbers may be repeated between figures where they are intended to represent similar features between otherwise varied embodiments, though those features may also incorporate certain differences between embodiments if and to the extent specified as such or otherwise apparent to one of ordinary skill, such as differences clearly shown between them in the respective figures.

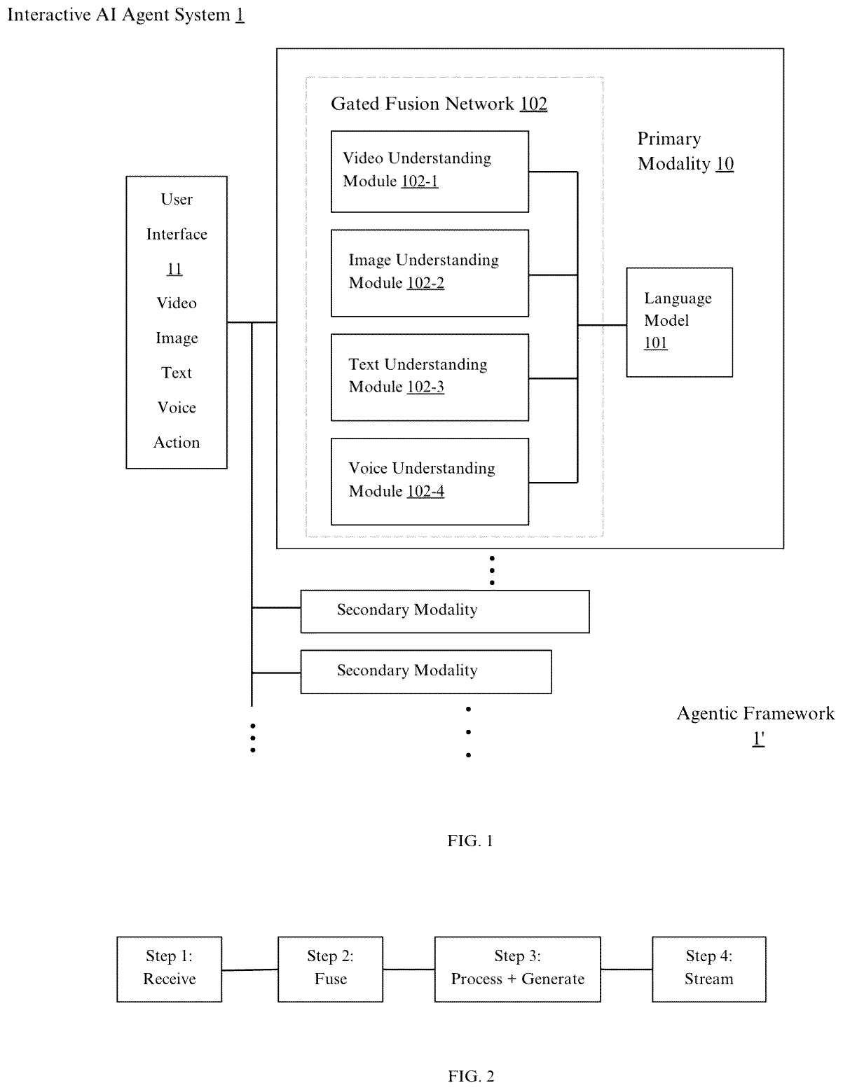

Reference is now made to FIG. 1, which is a diagram illustrating an architecture of the proposed interactive AI agent system, in accordance with aspects of the invention for interactive communication, enhanced user engagement and experience and consistent with embodiments of the present disclosure.

The interactive AI agent system is a multi-modal understanding and multi-modal generation AI system for streaming interactive applications, such as adaptive video streaming application. The interactive AI agent system 1 comprises at least one primary modality. In some embodiments, the interactive AI agent system 1 is structured as an agentic framework 1′ that comprises a primary modality 10 and a user interface 11.

Agentic framework 1′ is the foundational structure and architecture that enables the development, deployment, and management of autonomous AI agents-software entities capable of perceiving their environment, reasoning, planning, acting, and learning to achieve specific goals with minimal human intervention. In some embodiments, functionality wise, agentic framework 1′ comprises perception module, cognitive module, action module, learning module, collaboration module, and security module.

The perception module of agentic framework 1′ is configured to act as a sensory system, gathering and processing data from various sources (e.g., sensors, APIs, databases). It normalizes and extracts features from raw data, enabling the framework to interpret its environment.

The cognitive module of agentic framework 1′ is configured to function as the decision-making engine. It sets goals, plans strategies, makes decisions, and adapts through learning mechanisms. In some embodiments, this module leverages large language models (LLMs) and reinforcements learning to reason under uncertainty and optimize actions.

The action module of agentic framework 1′ is configured to execute decisions by interacting with external systems, automating tasks, and monitoring outcomes. It ensures that actions are safe, feasible, and aligned with the agent system's objectives.

The learning module of agentic framework 1′ is configured to enable the agent system to improve over time by analyzing feedback and historical data. This module supports continuous optimization, adaptation to new scenarios, and self-correction.

Referring to FIG. 1, the agentic framework 1′ comprises a primary modality 10 and a user interface 11. The agentic framework 1′ is configured to receive input content about a product or service, to utilize video rendering technologies, to react to stimulations extrinsic or intrinsic of the system, and to generate adaptive streaming output content. The primary modality 10 is configured to understand input from users and generate output content accordingly. The user interface 11 is configured to receive input from users and send to the primary modality 10, and to receive the output content from the primary modality 10 and send to the users.

In some embodiments, the primary modality 10 comprises a language model 101. The language model 101 is configured to receive input from intrinsic and extrinsic information. Extrinsic information is information generated from outside of the interactive AI agent system 1. Intrinsic information is information generated from inside of the interactive AI agent system 1. The language model 101 is further configured to process the information received, generate output content in response to the information, and stream the content to user interface 11.

In some other embodiments, the primary modality 10 comprises another type of model, e.g., visual model, audio model, etc., which serves the same purpose as a language model—to receive input, understand the then-current situation and users' needs, and generate output content in response to the situation and users' needs.

The primary modality 10 further comprises a gated fusion network 102 when there are multiple understanding modules in the system. The multiple understanding modules can be any two or more understanding modules of a video understanding module, an image understanding module, a text understanding module, and a voice understanding module. The gated fusion network 102 is configured to receive input from video understanding module 102-1, image understanding module 102-2, text understanding module 102-3, and voice understanding module 102-4.

The video information processed by video understanding module 102-1, the image information processed by image understanding module 102-2, the text information processed by text understanding module 102-3, and the voice or audio information processed by voice understanding module 102-4 are extrinsic information. The group of information is based on direct user input received from user interface 11 and reflects users' needs. The extrinsic stimulation of the system can also be an event.

At the same time, there is intrinsic information from the interactive AI agent system 1 within. In some embodiments, the language model 101 is pre-trained by background knowledge data. The language model 101 is therefore configured to, due to the pre-training by background knowledge data, spontaneously trigger some initiatives. In some other embodiments, the language model 101 is pre-trained by planning data. The language model 101 is therefore configured to, due to the pre-training by planning data, spontaneously trigger some initiatives. For example, such event or planning data is an American holiday calendar. If the language model 101 is pre-trained with such event and planning data, the interactive AI agent system 1 may, a few weeks in advance of the Independence Day, initiate pop-up window to order barbeque food and beverages, or check users' travel plan of the holiday, etc.

The gated fusion network 102 is configured to further fuse the input of video, image, text, and voice, to generate fused information that is understandable to AI language model 101. The gated fusion network is purported to integrate input from multiple channels and consolidate them into one input to the language model 101 so that the input is in an understandable state for the language model 101 to further process. Hence, information from the one or more understanding modules are grounded to the language model 101 of the primary modality 10.

Once the gated fusion network 102 fuses information from one or more modules and sends the fused information to the language model 101, the language model 101 is configured to understand the fused information, the language model 101 is further configured to generate output content to be sent to user interface 11. In some embodiments, the process of understanding and the process of generating output happen in parallel. They are configured to form a dynamic operational circle that is called simultaneous multimodal generation and understanding circle. The characteristic of the simultaneous multimodal circle is that while the output content is streaming, the language model 101 continues to receive fused information from gated fusion network 102 and is configured to respond instantly to the newly received fused information which may change or fine tune the output content under streaming. Despite the generating process is adaptive and keeping on updating, the output content streaming is designed the be continuous and smooth. The simultaneous multimodal generation and understanding circle is designed to create human-like interaction experience with users.

The user interface 11 is configured to stream the output content in one or more forms similar to the input information. The output content can be configured to be pure text messages, image or picture, voice or audio streaming, video streaming, or even taking actions on behalf of users. The user interface 11 is configured to provide versatile engagement channels with users, such as web browsers, QR code scan, search bar, standalone camera plus screen input, etc.

As an example, a user requests the interactive AI agent system 1 to make a travel plan in the week of July 4^{th}. In some embodiments, the user interface 11 is configured to stream a video in which an avatar talks and interacts with the user. The AI-generated avatar is configured to have realistic expressions, motions, gestures, and is equipped with multi-language capabilities. This AI avatar provides a more lifelike and engaging interaction with users, capturing user attention more effectively.

In the same example, after understanding sufficient input from the user, e.g., the days the user is free to travel, the place the user wants to visit, etc., actions suitable for the situation, e.g., exploring available air tickets, hotel reservations, searching for sightseeing spots, or drafting an email to employer of the user to apply for leave at work, etc. The agentic framework 1′ is configured to take these actions and execute tasks according to the need under the situation.

Overall, the interactive AI agent system 1 is configured to respond to multiple users simultaneously with different and customized output content in response to unique stimulations received during the interactions with the multiple users. In some embodiments, the interactive AI system 1 is comprised of multiple generative treemapping responses which all happen at the same time.

Reference is now made to FIG. 2, which is a workflow of using the interactive AI agent system to handle user input and generate output, in accordance with aspects of the invention for interactive communication, enhanced user engagement and experience and consistent with embodiments of the present disclosure. In any interaction session between user and the interactive AI agent system, the system is configured to take multiple steps to process input received from users and intrinsically and respond accordingly and take further actions on behalf of users if the algorithm decides appropriate.

At Step 1, the AI agent system 1 receives user input from a user in relation to information about a product or service via the user interface 11. Such input can be in the form of video, image, text, or voice. Depending on the form of the input, the information is to be sent to the corresponding understanding module to be processed, being it video understanding module, image understanding module, text understanding module, voice understanding module, or the combination of any of them.

At Step 2, each of the corresponding understanding modules is configured to process the input received. In some embodiments, the information is processed to one consolidated form of information, for example, text information. Information processed by each of the corresponding understanding modules is fused together by the gated fusion network before the fused information being sent to the language model 101.

At Step 3, the language model 101 is configured to process the fused information. In some embodiments, the language model 101 is pre-trained by generic world knowledge, information about the business and its products and services, etc. In some other embodiments, the language model 101 is further pre-trained by travel planning data, etc. After the language model 101 received the fused information based on user's input about a product or service, the language model 101 is configured to generate appropriate responses to user's input.

In some embodiments, the language model 101 is further configured to detect a specific event. For example, the event can be an input of a specific date on which the language model 101 is pre-trained to know as a birthday of a user. In response to the event detected, the language model 101 is configured to generate a corresponding output. In this example, the output can be a birthday greeting to the user, it can also be an action on behalf of the user like ordering a birthday cake of the user's favorite flavor.

In some embodiments, the language model 101 is further configured to act in accordance with a pre-trained plan. Such planning information is intrinsic stimulation of the AI agent system 1. For instance, the plan is to update the user with the newest feature of a product every three months. In this example, the output can be a conversation initiated to tell the user what the differences are of the current product in comparison to three months ago.

In some embodiments, the language model 101 is configured to render the processed information into a streaming content. Video rendering technologies are adopted in the AI agent system 1. A continuous video play allows the product or service to be showcased in a dynamic and real-time manner. At the same time, voice messages are synchronized with the mouth movements of the avatar in the video in real time to enhance the realism of the interaction.

At Step 4, output in the form of video, image, text, voice, action, or the combination of any of them are sent to users or external world via the user interface 11. In this step, the output content streamed from the modality, either a primary modality or a secondary modality, is to be converted to the final form of output to be sent to users or external world. In some embodiments, the modality is made up of a language model 101. Therefore, the output content streamed from the modality is text based. In some other embodiments, the modality is made up of a video model. Therefore, the output content streamed from the modality is video based. From there, the output content is converted into different forms of output to users after processed by corresponding interface modules.

In some embodiments, the output sent to the user via the user interface 11 is a video streaming of an avatar with voice synchronization. For instance, the user interacts with the AI agent system 1 to troubleshoot a problem with the product in hand. The output to the user is in the form of a video streaming of a human-figure avatar communicating with users in natural language with the voice of the user's choice.

In some other embodiments, the output sent to the user and the external world is a text message to user and an action to the external world. For instance, the user asks the AI agent system 1 to check if a restaurant reservation suitable for a team-bonding event in the evening has been made. The output to the user is in the form of a short text message “Not yet but let me book it for you now,” and at the same time, the AI agent system 1 goes on to make a reservation with the online booking system of the restaurant best suited for the purpose. For another instance, the user checks with the AI agent system 1 about the stock situation of medicine which the user needs to take every day. The output to the user in the form of a short text message can be “there are ten-day amount of medicine left; it normally takes three days for a refill to be delivered; let me order a refill for you now,” and at the same time, the AI agent system 1 goes on to order the medicine from the user's pharmacy.

The four steps of the process described above are configured to work in a dynamic and repeatable cycle. This means at the time the output is sent to user or the external world, the AI agent system 1 is configured to receive the input from users too. At any given point of time, there are one or more loops of the process ongoing. An input from the user is used to further fine tune or post train the modality's model so that the output is more adaptive, interactive, and customized to the user.

Moreover, in some embodiments, the four steps of the process described above are configured to work with multiple users simultaneously with different output content in response to different stimulations received from interactions with the multiple users. Multiple generative treemapping responses are generated and output at the same time.

Although the invention is illustrated and described herein with reference to specific embodiments, the invention is not intended to be limited to the details shown. Rather, various modifications can be made in the details within the scope of equivalents of the claims by anyone skill in the art without departing from the invention.

What is claimed:

1. A system of interactive AI agent, comprising:
a primary modality, further comprising
a gated fusion network, configured to ground one or more of video information, image information, text information, and voice information to fused information suitable for the process of an AI model; and
an AI model, configured to understand said fused information and generate output content in one or more forms of video, image, text, voice, and action; and
a user interface to interface with one or more users, configured to detect extrinsic or intrinsic stimulation and deliver said output content to the one or more users.

2. The system of claim 1, wherein said gated fusion network further configured to, by rendering, generate content based on said fused information.

3. The system of claim 1, wherein said AI model is a large language model.

4. The system of claim 1, wherein said understanding and said generating are processed simultaneously by said AI model.

5. The system of claim 1, wherein said AI model is further configured to constantly detect a triggering event and generate output to the detected triggering event.

6. The system of claim 1, wherein said AI model is further configured to respond according to a pre-arranged plan.

7. The system of claim 1, wherein said generated output content is streaming video.

8. A method for interacting with user of a product or service, comprising:
receiving one or more of video information, image information, text information, and voice information by a primary modality;
grounding received information to fused information by a gated fusion network;
understanding said fused information by an AI model;
generating output content in one or more forms of video, image, text, voice, and action by said AI model; and
delivering said output content to one or more users by a user interface.

9. The method of claim 8, further comprising:
rendering content generation based on said fused information.

10. The method of claim 8, wherein said AI model is a large language model.

11. The method of claim 8, wherein said understanding and said generating are processed simultaneously by said AI model.

12. The method of claim 8, further comprising constantly detecting a triggering event and generating output to the detected triggering event by said AI model.

13. The method of claim 8, further comprising responding according to a pre-arranged plan by said AI model.

14. The method of claim 8, wherein said generated output content is streaming video.

15. A non-transitory computer readable medium including a set of instructions that are executable by one or more processors of a computer to cause the computer to perform a method for interacting with user of a product or service, the method comprising:
receiving one or more of video information, image information, text information, and voice information by a primary modality;
grounding received information to fused information by a gated fusion network;
understanding said fused information by an AI model;
generating output content in one or more forms of video, image, text, voice, and action by said AI model; and
delivering said output content to one or more users by a user interface.

16. The method of claim 15, further comprising:
rendering content generation based on said fused information.

17. The method of claim 15, wherein said AI model is a large language model.

18. The method of claim 15, wherein said understanding and said generating are processed simultaneously by said AI model.

19. The method of claim 15, further comprising constantly detecting a triggering event and generating output to the detected triggering event by said AI model.

20. The method of claim 15, further comprising responding according to a pre-arranged plan by said AI model.

21. The method of claim 15, wherein said generated output content is streaming video.
